(19) United States
(12) Patent Application Publication
(10) Pub. No.: US 2007/0070837 A1
(43) Pub. Date: Mar. 29, 2007

(54) Disc drive apparatus

(75) Inventors: Marcel Francois Heertjes, Eindhoven (NL); Frank Bernhard Sperling, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/577,100

(22) PCT Filed: Oct. 13, 2004
(86) PCT No.: PCT/IB04/52077

§ 371 Date: Apr. 25, 2006

(30) Foreign Application Priority Data
Oct. 28, 2003 (EP) 03103990.2

(51) Int. Cl. G11B 7/00

(52) U.S. Cl. 369/44.29

(57) ABSTRACT

A method is described for controlling an optical disc drive apparatus (1) of a type comprising: scanning means (30) for scanning a record track of an optical disc (2), said scanning means (30) comprising at least one read/write element (34) to be positioned with respect to the disc (2), and at least one optical detector (35) for generating a read signal (S_{R}); actuator means (50) for controlling the positioning of said at least one read/write element (34); a control circuit (290) for receiving said read signal (S_{R}) and generating at least one actuator control signal (S_{CR}) on the basis of at least one signal component of said read signal (S_{R}), the control circuit (290) having at least one variable gain (γ); said control circuit (290), said actuator means (50), said read/write element (34), and said optical detector (35) defining a control loop (200) having a critical frequency (ω_{CP}); the method comprises the steps of: selectively setting the gain (γ), for signal components having a frequency in a predefined range corresponding to said critical frequency (ω_{CP}), to a value lower than a value for signal components having a frequency outside said range.

### FIELD OF THE INVENTION

The present invention relates in general to a disc drive apparatus for writing/reading information into/from a storage disc. Although the gist of the invention also applies to magnetic discs, the present invention specifically applies to optical discs, for which reason the invention will hereinafter be described for optical discs, while the corresponding disc drive apparatus will also be indicated as “optical disc drive”.

### BACKGROUND OF THE INVENTION

As is commonly known, an optical storage disc comprises at least one track, either in the form of a continuous spiral or in the form of multiple concentric circles, of storage space where information may be stored in the form of a data pattern. Optical discs may be read-only type, where information is recorded during manufacturing, which information can only be read by a user. The optical storage disc may also be a writeable type, where information may be stored by a user. For writing information in the storage space of the optical storage disc, or for reading information from the disc, an optical disc drive comprises, on the one hand, rotating means for receiving and rotating an optical disc, and on the other hand optical means for generating an optical beam, typically a laser beam, and for scanning the storage track with said laser beam. Since the technology of optical discs in general, the way in which information can be stored in an optical disc, and the way in which optical data can be read from an optical disc, is commonly known, it is not necessary here to describe this technology in more detail.

For rotating the optical disc, an optical disc drive typically comprises a motor, which drives a hub engaging a central portion of the optical disc. Usually, the motor is implemented as a spindle motor, and the motor-driven hub may be arranged directly on the spindle axle of the motor.

For optically scanning the rotating disc, an optical disc drive comprises a light beam generator device (typically a laser diode), an objective lens for focussing the light beam in a focal spot on the disc, and an optical detector for receiving the reflected light reflected from the disc and for generating an electrical detector output signal. The optical detector comprises multiple detector segments, each segment providing an individual segment output signal.

During operation, the light beam should remain focussed on the disc. To this end, the objective lens is arranged axially displaceable, and the optical disc drive comprises focal actuator means for controlling the axial position of the objective lens. Further, the focal spot should remain aligned with a track or should be capable of being positioned with respect to a new track. To this end, at least the objective lens is mounted radially displaceable, and the optical disc drive comprises radial actuator means for controlling the radial position of the objective lens.

In many disc drives, the objective lens is arranged tiltably, and such optical disc drive comprises tilt actuator means for controlling the tilt angle of the objective lens.

For controlling these actuators, the optical disc drive comprises a controller, which receives an output signal from the optical detector. From this signal, hereinafter also referred to as read signal, the controller derives one or more error signals, such as for instance a focus error signal, a radial error signal, and, on the basis of these error signals, the controller generates actuator control signals for controlling the actuators such as to reduce or eliminate position errors.

In the process of generating actuator control signals, the controller shows a certain control characteristic. Such control characteristic is a feature of the controller, which may be described as the way in which the controller behaves as reaction to detecting position errors.

Position errors may, in practice, be caused by different types of disturbances. The two most important classes of disturbances are:
1) disc defects
2) external shocks and (periodic) vibration

The first category comprises internal disc defects like black dots, pollution like fingerprints, damage like scratches, etc. The second category comprises shocks caused by an object colliding to the disc drive, but shocks and vibrations are mainly to be expected in portable disc drives and automobile applications.

A problem in this respect is that adequately handling disturbances of the first category requires a different control characteristic than adequately handling disturbances of the second category. Conventionally, the controller of a disc drive has a fixed control characteristic, which is either specifically adapted for adequately handling disturbances of the first category (in which case error control is not optimal in the case of disturbances of the second category) or specifically adapted for adequately handling disturbances of the second category (in which case error control is not optimal in the case of disturbances of the first category), or the control characteristic is a compromise (in which case error control is not optimal in the case of disturbances of the first category as well as in the case of disturbances of the second category). As long as a controller applies linear control technique, there is always a compromise between low-frequency disturbance rejection and high-frequency sensitivity to noise.

In the state of the art, it has already been proposed to change the control characteristic of the controller, depending on the type of disturbance experienced. For instance, reference is made to U.S. Pat. No. 4,722,079, which discloses a disc drive apparatus where the gain of the controller is adapted.

Apart from determining type of disturbance, and adapting the control characteristics in relation to the type of disturbance, it is possible to perform a quantitative assessment of the disturbance, and to adapt the control characteristics in relation to the severity of the disturbance. For instance, in the case of a mechanical shock, not only may the controller gain be increased, but the amount of increase may depend on the strength of the shock. The higher the controller gain, the better the drive can resist a strong mechanical shock. Thus, the performance of the drive in the case of strong mechanical shocks depends on the maximum gain increase possible.

A general problem in this respect is that the gain can not be increased unlimitedly; if the gain is set too high, the control loop of the controller may get unstable. Thus, a general objective of the present invention is to provide a method for increasing the controller gain further without increasing the risk of instability of the controller.

Further, it is an objective of the present invention to provide a method for dynamically amending a controller characteristic such as to reduce the risk of instability of the controller.

### SUMMARY OF THE INVENTION

According to an important aspect of the present invention, the gain increase in the case of a shock not only depends on the strength of the shock but also depends on the characteristic frequency of the shock. If the shock has a relatively low or relatively high associated frequency, the gain is increased to a relatively large extent. If the shock has an associated frequency in a predetermined frequency range associated with instability risks, the gain is increased to a relatively small extent. In fact, in said predetermined frequency range, the gain may be kept constant, or may even be reduced.

### BRIEF DESCRIPTION OF THE DRAWINGS

These and other aspects, features and advantages of the present invention will be further explained by the following description with reference to the drawings, in which same reference numerals indicate same or similar parts, and in which:

FIG. 1A schematically illustrates relevant components of an optical disc drive apparatus;

FIG. 1B schematically illustrates an embodiment of an optical detector in more detail;

FIG. 2A is a block diagram, schematically illustrating a tracking control loop;

FIG. 2B is a block diagram of a replacement circuit for an amplifier;

FIG. 2C is a graph showing a Nyquist plot of the overall transfer function of a closed loop without the invention being implemented;

FIG. 3A is a block diagram, schematically illustrating a tracking control loop according to the present invention;

FIG. 3B is a graph illustrating a possible frequency characteristic of a dynamic filter suitable for use in implementing the present invention;

FIG. 3C is a graph schematically illustrating variable gain behaviour;

FIG. 3D is a graph showing a Nyquist plot of the overall transfer function of a closed loop corresponding to the control loop of FIG. 3A.

### DESCRIPTION OF THE INVENTION

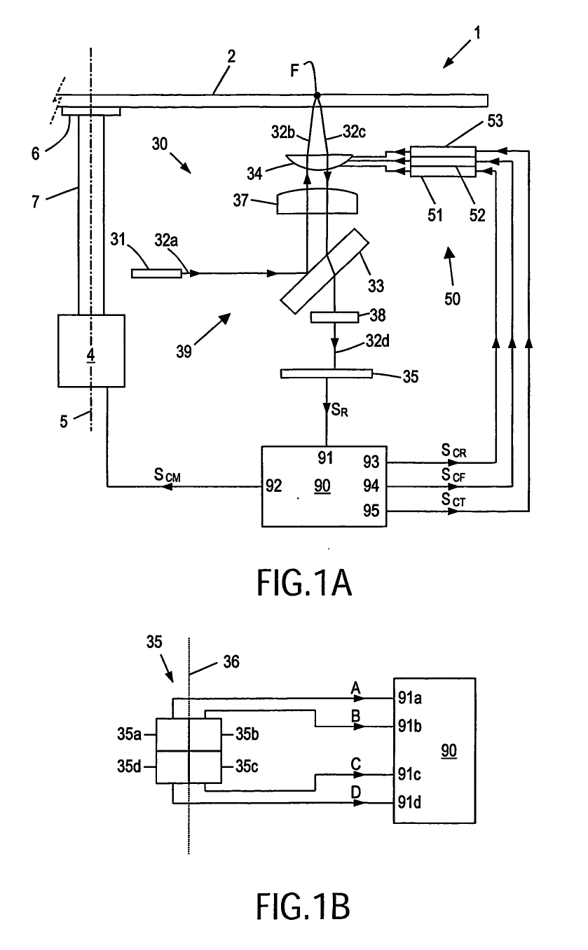

FIG. 1A schematically illustrates an optical disc drive apparatus 1, suitable for storing information on or reading information from an optical disc 2, typically a DVD or a CD. For rotating the disc 2, the disc drive apparatus 1 comprises a motor 4 fixed to a frame (not shown for sake of simplicity), defining a rotation axis 5.

The disc drive apparatus 1 further comprises an optical system 30 for scanning tracks (not shown) of the disc 2 by an optical beam. More specifically, in the exemplary arrangement illustrated in FIG. 1A, the optical system 30 comprises a light beam generating means 31, typically a laser such as a laser diode, arranged to generate a light beam 32. In the following, different sections of the light beam 32, following an optical path 39, will be indicated by a character a, b, c, etc added to the reference numeral 32.

The light beam 32 passes a beam splitter 33, a collimator lens 37 and an objective lens 34 to reach (beam 32b) the disc 2. The objective lens 34 is designed to focus the light beam 32b in a focal spot F on a recording layer (not shown for sake of simplicity) of the disc. The light beam 32b reflects from the disc 2 (reflected light beam 32c) and passes the objective lens 34, the collimator lens 37, and the beam splitter 33, to reach (beam 32d) an optical detector 35. In the case illustrated, an optical element 38 such as for instance a prism is interposed between the beam splitter 33 and the optical detector 35.

The disc drive apparatus 1 further comprises an actuator system 50, which comprises a radial actuator 51 for radially displacing the objective lens 34 with respect to the disc 2. Since radial actuators are known per se, while the present invention does not relate to the design and functioning of such radial actuator, it is not necessary here to discuss the design and functioning of a radial actuator in great detail.

For achieving and maintaining a correct focusing, exactly on the desired location of the disc 2, said objective lens 34 is mounted axially displaceable, while further the actuator system 50 also comprises a focal actuator 52 arranged for axially displacing the objective lens 34 with respect to the disc 2. Since focal actuators are known per se, while further the design and operation of such focal actuator is no subject of the present invention, it is not necessary here to discuss the design and operation of such focal actuator in great detail.

For achieving and maintaining a correct tilt position of the objective lens 34, the objective lens 34 is mounted pivotably, while further the actuator system 50 also comprises a tilt actuator 53 arranged for pivoting the objective lens 34 with respect to the disc 2. Since tilt actuators are known per se, while further the design and operation of such tilt actuator is no subject of the present invention, it is not necessary here to discuss the design and operation of such tilt actuator in great detail.

It is further noted that means for supporting the objective lens with respect to an apparatus frame, and means for axially and radially displacing the objective lens, as well as means for pivoting the objective lens, are generally known per se. Since the design and operation of such supporting and displacing means are no subject of the present invention, it is not necessary here to discuss their design and operation in great detail.

It is further noted that the radial actuator 51, the focal actuator 52 and the tilt actuator 53 may be implemented as one integrated actuator.

The disc drive apparatus 1 further comprises a control circuit 90 having a first output 92 connected to a control input of the motor 4, having a second output 93 coupled to a control input of the radial actuator 51, having a third output 94 coupled to a control input of the focal actuator 52, and having a fourth output 95 coupled to a control input of the tilt actuator 53. The control circuit 90 is designed to generate at its first output 92 a control signal S_{CM} for controlling the motor 4, to generate at its second control output 93 a control signal S_{CR} for controlling the radial actuator 51, to generate at its third output 94 a control signal S_{CF} for controlling the focal actuator 52, and to generate at its fourth output 95 a control signal S_{CT} for controlling the tilt actuator 53.

The control circuit 90 further has a read signal input 91 for receiving a read signal SR from the optical detector 35.

FIG. 1B illustrates that the optical detector 35 comprises a plurality of detector segments, in this case four detector segments 35a, 35b, 35c, 35d, capable of providing individual detector signals A, B, C, D, respectively, indicating the amount of light incident on each of the four detector segments, respectively. The detector segments 35a, 35b, 35c, 35d, also indicated as central aperture detector segments, are arranged in a four-quadrant configuration. A centre line 36, separating the first and fourth segments 35a and 35d from the second and third segments 35b and 35c, has a direction corresponding to the track direction. Since such four-segment detector is commonly known per se, it is not necessary here to give a more detailed description of its design and functioning.

FIG. 1B also illustrates that the read signal input 91 of the control circuit 90 actually comprises a plurality of inputs for receiving all individual detector signals. Thus, in the illustrated case of a four-quadrant detector, the read signal input 91 of the control circuit 90 actually comprises four inputs 91a, 91b, 91c, 91d for receiving said individual detector signals A, B, C, D, respectively. The control circuit 90 is designed to process said individual detector signals A, B, C, D, in order to derive data and control information therefrom, as will be clear to a person skilled in the art For instance, a normalized radial error signal REn can be defined according to

$$REn = \frac{( A + D ) - ( B + C )}{A + B + C + D} \qquad ( 1 )$$

Further, a normalized focus error signal FEn can be defined according to

$$FEn = ( \frac{A - D}{A + D} ) - ( \frac{B - C}{B + C} ) \qquad ( 2 )$$

These signals REn and FEn each are a measure for a certain kind of asymmetry of the central optical spot on the detector 35, and hence are sensitive to displacement of the optical scanning spot with respect to the disc.

It is noted that, depending on the design of the optical detector, different definitions for error signals may be used.

In the following, the present invention will be explained specifically for the case of controlling the radial actuator 51, but it should be clear that the same, or at least a similar, explanation applies in the case of focus control, tilt control, etc.

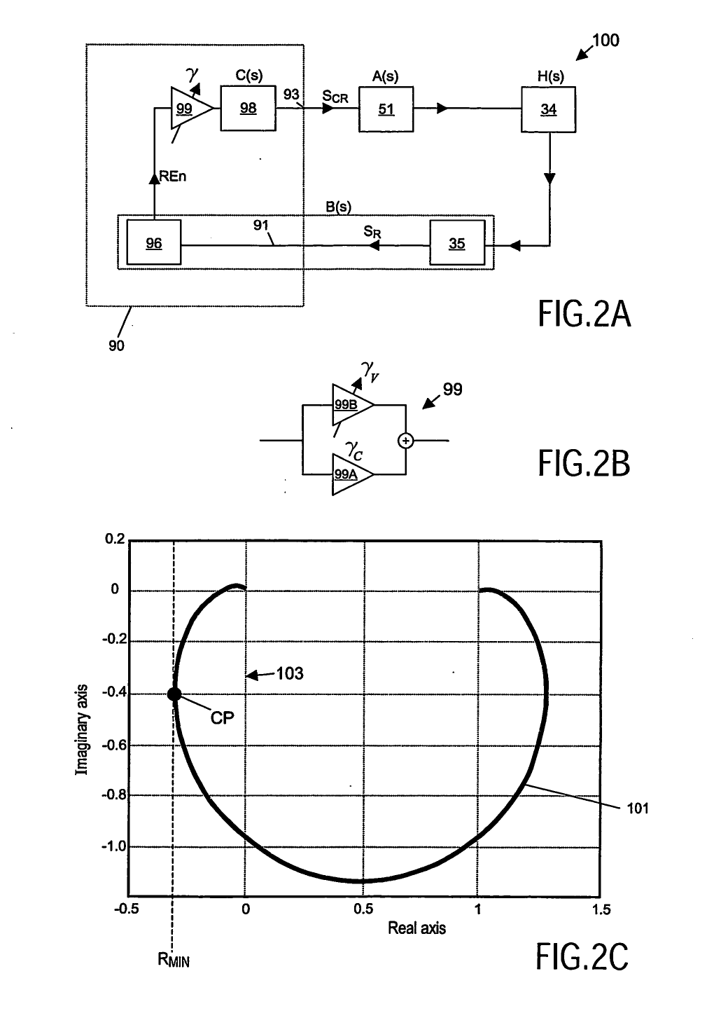

FIG. 2A is a simplified block diagram, schematically illustrating a tracking control loop 100. The control circuit 90 generates a control signal S_{CR} for the radial actuator 51, which causes a displacement of the lens 34. A transfer function of the radial actuator 51, representing the relationship between control signal S_{CR} and resulting actuator force, is indicated as A(s).

A transfer function of the lens 34, representing the relationship between actuator force and resulting lens displacement, is indicated as H(s); it is noted that, in a simplified model, H may be written as

$$H ( s ) = \frac{1}{{ms}^{2}}$$

wherein m indicates the mass of the lens 34.

The displacement of the lens 34 causes a change in the optical beam position, which is detected by the detector 35, resulting in a change of the optical read signal S_{R}. An error signal calculator 96 of the control circuit 90 calculates the radial error signal REn from the optical read signal S_{R}. A transfer function of the combination of detector 35 and error signal calculator 96, representing the relationship between lens displacement and radial error signal REn, is indicated as B(s). It is noted that the transfer (gain) of error signal calculator 96 is equal to 1, per definition, since this circuit only calculates a relative positional error from the absolute beam and track positions.

A control signal generator part 98 of the control circuit 90, for instance a PID controller, generates the control signal S_{CR} on the basis of the radial error signal REn. A transfer function of the control signal generator part 98, representing the relationship between radial error signal REn and control signal S_{CR}, is indicated as C(s).

It is assumed that all of said transfer functions are fixed.

For allowing variable control characteristics, the control circuit 90 comprises an amplifier 99 with variable gain γ, in this example arranged between the error signal calculator 96 and the control signal generator part 98. The gain γ can be written as γ=γ_{C}+γ_{V}, wherein γ_{C} indicates a constant part of the gain while γ_{V} indicates a variable part of the gain. FIG. 2B is a block diagram of a replacement circuit for the amplifier 99, showing the amplifier 99 as a parallel combination of a constant amplifier 99A having constant gain γ_{C} and a variable amplifier 99B having variable gain γ_{V}.

The design of the control circuit 90 should be such that the system is stable in the linear situation, i.e. when γ_{V}=0. In this linear situation, a closed loop transfer function G(s) can be written as

$$G ( s ) = \frac{X ( s )}{1 + {γ}_{c} \cdot X ( s )}$$

wherein X(s)=C(s)-A(s)-H(s)-B(s).

As will be clear to persons skilled in the art, this closed loop transfer function G(s) describes the transfer of a small disturbance at the input of control signal generator 98 to the output of error signal calculator 96 (or the output of detector (35), in a case when the servo loops are in operation.

FIG. 2C is a graph showing a Nyquist plot, indicated by reference numeral 101, of the frequency response of an exemplary closed loop transfer function G(s) of the control loop 100. The horizontal axis represents the real part Re(G(jω)), while the vertical axis represents the imaginary part Im(G(jω)). The upper-right end of the curve 101 corresponds to ω=0, while the upper-left end of the curve 101 corresponds to ω=∞.

The control circuit 90 is capable of detecting shock, and to adapt its control characteristics when a shock situation is detected. More particularly, the control circuit 90 is designed to increase γ_{V} in the case of a shock being detected, wherein the magnitude of the gain increase depends on the magnitude of the shock experienced. It is noted that control circuits employing shock detection and amending their gain in response are known per se; therefore, it is not necessary here to discuss this aspect in more detail. Particularly, the method of shock detection is not important in this respect, since the present invention can be implemented in conjunction with any kind of shock detection method, although methods are preferred which allow a quantitative shock magnitude detection.

In FIG. 2C, a critical point CP, indicated at 103, is defined as the point of the closed loop transfer function G(s) where the real part Re(G(jω)) has the lowest value R_{MIN}. The frequency corresponding to this critical point CP will be indicated as critical frequency ω_{CP}. As will be clear to a person skilled in the art, the value of R_{MIN} determines a maximum for γ_{V}: the lower R_{MIN} (i.e. the higher |R_{MIN}|), the lower the maximum for γ_{V} can be. If γ_{V} is above this maximum when a shock occurs having a frequency in the range of the critical frequency ω_{CP}, the system may get unstable.

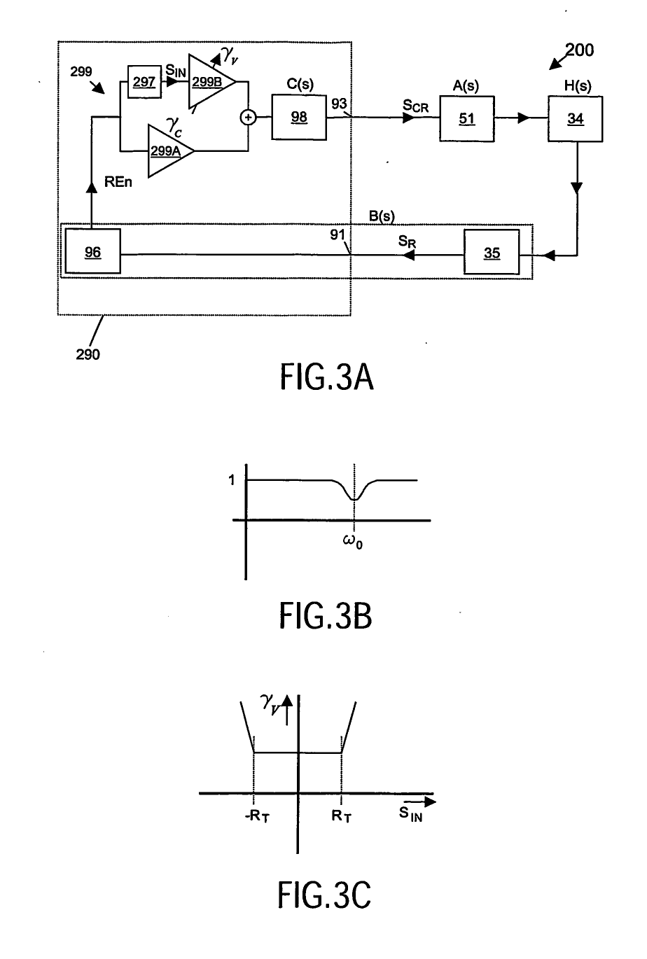

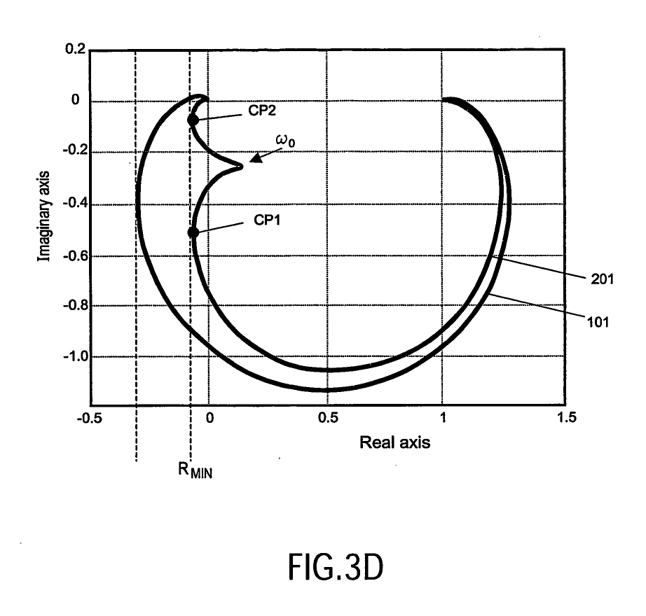

FIG. 3A is a block diagram, comparable to FIG. 2A, schematically illustrating a radial control loop 200 in which the present invention is implemented. In this case, a control circuit 290 comprises an additional dynamic filter 297, which is shown as being arranged before the input of the variable amplifier 299B part of amplifier 299. The filter action can be considered as introducing a frequency-dependent attenuation F(s); the new closed loop transfer function G′(s) can be written as G′(s)=G(s)·F(s).

The dynamic filter 297 is designed to selectively suppress frequencies in the range of the critical frequency ω_{CP}. Suitably, the dynamic filter 297 is designed as a band-reject filter or notch filter, having a central frequency ω₀ approximately equal to the critical frequency ω_{CP}, as illustrated in FIG. 3B. It is noted that the filter 297 might also be designed as a low-pass filter.

FIG. 3C is a graph, schematically illustrating the variable gain behaviour of variable amplifier part 299B according to the present invention. The horizontal axis represents the magnitude (arbitrary units) of a signal S_{IN} received at the input of variable amplifier part 299B, the vertical axis represents the resulting gain γ_{V} (arbitrary units). For small signals, having a magnitude below a threshold R_{T}, the variable gain γ_{V} remains equal to zero. Only if the signal magnitude is above said threshold R_{T}, the variable gain γ_{V} is above zero. In principle, it is possible that the variable gain γ_{V} is switched between zero and a constant high value, but preferably, as illustrated, the variable gain γ_{V} increases proportionally with the signal magnitude, although this does not need to involve a linear relationship.

The operation of control circuit 290 is as follows. The optical read signal S_{R} is monitored and processed to detect shocks. Alternatively, a separate shock detector may be provided, for instance a mechanical shock sensor, but this is not shown in FIG. 3A. As long as no shocks are experienced, or for relatively small errors, the variable gain γ_{V}=0, so that the gain γ=γ_{C}, independent of the frequency of these errors.

For larger errors, having a signal magnitude above said threshold R_{T}, the variable gain is increased if the error frequency is outside the reject range of the filter 297. If the error frequency is within the reject range of the filter 297, the input signal S_{IN} of the variable amplifier part 299B is lower than the error signal magnitude, so that the gain increase is reduced. Close to the central frequency ω₀ of the filter 297, the suppression will be such that the input signal S_{IN} of the variable amplifier part 299B is lower than said threshold R_{T}, so that the variable gain γ_{V} remains equal to zero for such frequencies.

FIG. 3D is a graph, comparable to FIG. 2C, showing a Nyquist plot of the new closed loop frequency response G′(s) of the control loop 200, indicated by reference numeral 201, for an example where the filter 297 is a notch filter. For easy reference, original curve 101 of original closed loop transfer function G(s) is also shown. Original curve 101 may be regarded as illustrating the response of the inventive control loop 200 for the case of small radial errors, whereas curve 201 illustrates the response of the inventive control loop 200 for the case of large error magnitudes. The effect of the filter 297 can easily be recognized. In effect, the filter 297 shapes the closed loop frequency response such that response at the critical frequency ω_{CP} is lower than the response at other frequencies.

Original curve 101 may also be regarded as illustrating the response of a control loop without the filter 297 (which is equivalent to the inventive control loop 200 with the filter 297 switched off), for the case of large error magnitudes and for a certain value of the constant gain γ_{C}, whereas curve 201 illustrates the response of the inventive control loop 200 for the case of the same error magnitudes and the same value of the constant gain γ_{C}. In the case of prior art control loop 100 (or inventive control loop 200 with the filter 297 switched off), these error magnitudes lead to a variable gain γ_{V} setting which may be the same for all frequencies, resulting in curve 101. In the case of the inventive control loop 200 (i.e. with the filter 297 switched on), the same error magnitudes lead to a variable gain γ_{V} setting which is relatively low around the critical frequency ω_{CP}. Thus, the effect of the filter 297 is that the absolute value of R_{MIN} is reduced. Consequently, the allowable maximum for the variable gain γ_{V} is increased.

It is noted that the exact value of the central frequency ω₀ of the notch filter 297 depends on the critical frequency ω_{CP} of the control loop 200, i.e. the frequency where the transfer function G′(s) would have its minimum R_{MIN} with the filter 297 switched off (i.e. with the filter transfer function being equal to 1 for all frequencies). Typically, the design is such that the critical frequency ω_{CP} of the control loop 200 is relatively high, i.e. typically above 2000 Hz, which is well above the frequency range corresponding to mechanical shocks, so that the overall frequency response in the frequency range corresponding to mechanical shocks is substantially undisturbed.

In the example discussed, filter 297 is a notch filter. As an alternative, it is possible to use a low-pass filter, having its cut-off frequency well above the frequency range where shocks are to be expected. Since shocks typically have frequencies below 200 Hz, an adequate choice for such cut-off frequency is in a range above 2000 Hz. Also, an adequate choice for such cut-off frequency is approximately equal to the original critical frequency ω_{CP}. However, since the critical point CP should be displaced to the right as much as possible, the cut-off frequency is preferably chosen below the the original critical frequency

In the case of the filter 297 being a notch filter, an adequate design choice would be to choose the central frequency ω₀ of the notch filter to be equal to the frequency corresponding with original critical point CP. However, in an ideal case as illustrated in FIG. 3D, the central frequency ω₀ of the notch filter is chosen such that the closed loop transfer function G′(s) has two critical points CP1 and CP2, i.e. the lowest value R_{MIN} for Re(G′) is obtained for two frequencies ω1 and ω2, one below ω0 and one above ω0.

It should be clear to a person skilled in the art that the present invention is not limited to the exemplary embodiments discussed above, but that several variations and modifications are possible within the protective scope of the invention as defined in the appending claims.

For instance, it is possible that the filter 297 and the amplifier 299 are integrated into one signal processing component.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, etc.

1. Method for controlling a disc drive apparatus (1), the disc drive apparatus (1) comprising:
scanning means (30) for scanning a record track of a disc (2), said scanning means (30) comprising at least one read/write element (34) to be positioned with respect to the disc (2), and at least one detector (35) for generating a read signal (S_{R});
actuator means (50) for controlling the positioning of said at least one read/write element (34);
a control circuit (290) for receiving said read signal (S_{R}) and generating at least one actuator control signal (S_{CR}) on the basis of at least one signal component of said read signal (S_{R}), the control circuit (290) having at least one variable gain (γ);
said control circuit (290), said actuator means (50), said read/write element (34), and said detector (35) defining a control loop (200) having a critical frequency (ω_{CP})
the method comprising the steps of:
for signal components having a frequency in a predefined range corresponding to said critical frequency (ω_{CP}), selectively setting the gain (γ) to a value lower than a value for signal components having a frequency outside said range.

2. Method according to claim 1, wherein said gain (γ) has a constant value (γ_{C}) for signal components having a magnitude below a predefined shock threshold (R_{T});
wherein, for signal components having a magnitude above said predefined shock threshold (R_{T}), said gain (γ) is increased by a variable value (γ_{V});
wherein said gain increase (γ_{V}) is lower for signal components having a frequency inside said predefined range as compared to the gain increase (γ_{V}) for signal components having a frequency outside said range.

3. Method according to claim 2, wherein said constant value (γ_{C}) corresponds to a linear control design.

4. Method according to claim 1, comprising the steps of:
receiving said read signal (S_{R});
dynamically filtering said read signal (S_{R});
applying a first gain (γ_{C}) to filtered signal components having a magnitude below a predefined shock threshold (R_{T}), and applying a second gain (γ_{C}+γ_{V}) higher than said first gain (γ_{C}) to filtered signal components having a magnitude above said predefined shock threshold (R_{T}).

5. Method according to claim 4, wherein the step of dynamically filtering comprises the step of selectively suppressing signal components having a frequency in the proximity of said critical frequency (ω_{CP})

6. Method according to claim 4, wherein said gain increase (γ_{V}) is proportional to the magnitude of the corresponding filtered signal components.

7. Method according to claim 1, wherein said actuator means (50) comprises a radial actuator (51), and wherein said variable gain (γ) is a gain in the radial control loop for controlling said radial actuator (51).

8. Method according to claim 1, wherein said actuator means (50) comprises a focal actuator (52), and wherein said variable gain (γ) is a gain in the focal control loop for controlling said focal actuator (52).

9. Method according to claim 1, wherein said actuator means (50) comprises a tilt actuator (53), and wherein said variable gain (γ) is a gain in the tilt control loop for controlling said tilt actuator (53).

10. Control circuit (290) for use in a disc drive apparatus (1), comprising:
an input (91) for receiving a read signal (SR) from a detector (35);
at least one output (93) for providing at least one actuator control signal (S_{CR}) on the basis of at least one signal component (REn) of said read signal (S_{R});
the control circuit (290) having a variable gain (γ);
the control circuit (290) being adapted to set its gain (γ) depending on whether or not shocks are experienced, and/or depending on the magnitude of shocks;
the control circuit (290) comprising a dynamic filter (297) which attenuates signal components having a frequency within a predefined frequency range.

11. Control circuit according to claim 10, wherein the said dynamic filter (297) comprises a notch filter.

12. Control circuit according to claim 10, wherein the said dynamic filter (297) comprises a low-pass filter.

13. Control circuit according to claim 10, comprising a variable amplifier (299) which comprises:
a constant amplifier part (299A) providing a constant gain (γ_{C}); and
a variable amplifier part (299B) providing a variable gain (γ_{V}); wherein said dynamic filter (297) is arranged at the input of said variable amplifier part (299B).

14. Disc drive apparatus (1) comprising:
scanning means (30) for scanning a record track of a disc (2), said scanning means (30) comprising at least one read/write element (34) to be positioned with respect to the disc (2), and at least one detector (35) for generating a read signal (S_{R});
actuator means (50) for controlling the positioning of said at least one read/write element (34);
a control circuit (290) for receiving said read signal (S_{R}) and generating at least one actuator control signal (S_{CR}) on the basis of at least one signal component of said read signal (S_{R}), the control circuit (290) having at least one variable gain (γ); said control circuit (290), said actuator means (50), said read/write element (34), and said detector (35) defining a control loop (200) having a critical frequency (ω_{CP});
the control circuit (290) being adapted to perform the method of claim 1.

15. Disc drive apparatus (1) comprising:
scanning means (30) for scanning a record track of a disc (2), said scanning means (30) comprising at least one read/write element (34) to be positioned with respect to the disc (2), and at least one detector (35) for generating a read signal (S_{R}); actuator means (50) for controlling the positioning of said at least one read/write element (34);
a control circuit (290) according to claim 10 for receiving said read signal (S_{R}) and generating at least one actuator control signal (S_{CR}) on the basis of at least one signal component of said read signal (S_{R}), the control circuit (290) having at least one variable gain (γ);
said control circuit (290), said actuator means (50), said read/write element (34), and said detector (35) defining a control loop (200) having a critical frequency (ω_{CP}).

16. Disc drive apparatus according to claim 15, wherein said predefined frequency range of said dynamic filter (297) corresponds to said critical frequency (ω_{CP}) of said control loop (200).

17. Disc drive apparatus according to claim 14, wherein said actuator means (50) is designed for controlling a radial position of said at least one read/write element (34) and/or for controlling an axial position of said at least one read/write element (34) and/or for controlling an tilt position of said at least one read/write element (34).

18. Disc drive apparatus according to claim 14, wherein said detector (35) comprises an optical detector.
